(19) United States
(12) Patent Application Publication
(10) Pub. No.: US 2008/0203733 A1
(43) Pub. Date: Aug. 28, 2008

(54) Tidal Generator

(76) Inventor: Anthony Martindale, Warwickshire (GB)

Correspondence Address: AMSTER, ROTHSTEIN & EBENSTEIN LLP, 90 PARK AVENUE, NEW YORK, NY, 10016, US

(21) Appl. No.: 11/793,539

(22) PCT Filed: Dec. 22, 2005
(86) PCT No.: PCT/GB2005/004998

§ 371 Date: Nov. 13, 2007

(30) Foreign Application Priority Data
Dec. 22, 2004 (GB) 0428089.7

(51) Int. Cl. F03B 13/26

(52) U.S. Cl. 290/53; 415/7

(57) ABSTRACT

A device for harnessing tidal energy, comprising: a vertically elongate chamber at least partially located in a tidal body of liquid; a separating member movable within the chamber either vertically or along, and configured to seal from each other an upper interior region of the chamber above the member and a lower region of the chamber below the member, the chamber having a first opening whereby the lower interior region may communicate with the body of liquid and a second opening whereby the upper interior region may communicate with the air, the same or another body of liquid; energy harnessing means for harnessing (potential) energy from the change in pressure due to change in height caused by change in tide level. Energy recuperation from flow of fluid through the first or second or multiple openings; and restraining means for releasably restraining the motion of the separating member in the chamber.

This invention relates to the harnessing of tidal energy, for example to generate electricity or other forms of energy, whether directly or indirectly.

As concern for the environment grows there is increasing interest in renewable energy sources such as wind, wave and tidal power. Numerous schemes for harnessing tidal power have been developed. These generally employ an electricity generating turbine at the mouth of a barrage, which is driven by tidal flows into and out of the reservoir behind the barrage.

A major disadvantage of such tidal generation schemes is that they can only provide power at periods of the day when there is a tidal flow. Although the timing of the tides changes from day to day, often the tidal flow will not be synchronised with peak demand for electricity. Therefore, tidal schemes are not good at meeting the variation in demand for power over the course of a day. Tidal barrages also disrupt the natural habitat of marine life and inhibit access between rivers and the sea by boat.

In contrast, wind and wave generation schemes can provide power more uniformly over time. However, they are located on land or on the surface of the sea, and can be unpopular because of their obtrusive appearance. They are dependent on the weather, which is not as reliable as the tides.

There is therefore a need for an improved way of harnessing natural energy.

According to the present invention there is provided a device for harnessing tidal energy, comprising: a vertically elongate chamber at either partially or fully submerged in a tidal body of liquid; a separating member movable in the chamber and configured to seal from each other an upper interior region of the chamber above the member and a lower region of the chamber below the member, the chamber having a first opening whereby the lower interior region may communicate with the body of liquid and a second opening whereby the upper interior region may communicate with one or more of the atmosphere, the said tidal body of liquid or another body of liquid; energy harnessing means for harnessing energy from the flow of fluid through the first or second opening; and restraining means for releasably restraining the motion of the separating neutral buoyancy member in the chamber.

The separating member is preferably of neutral buoyancy or substantially neutral buoyancy. The separating member is preferably movable vertically (i.e. between locations that are vertically offset from one another) in the chamber.

The vertically elongate chamber may be run vertically or substantially vertically, or it may be significantly angled to the vertical.

Further advantageous embodiments are described in dependent claims 2 to 7.

The present invention will now be described by way of example with reference to the accompanying drawings.

In the drawings:

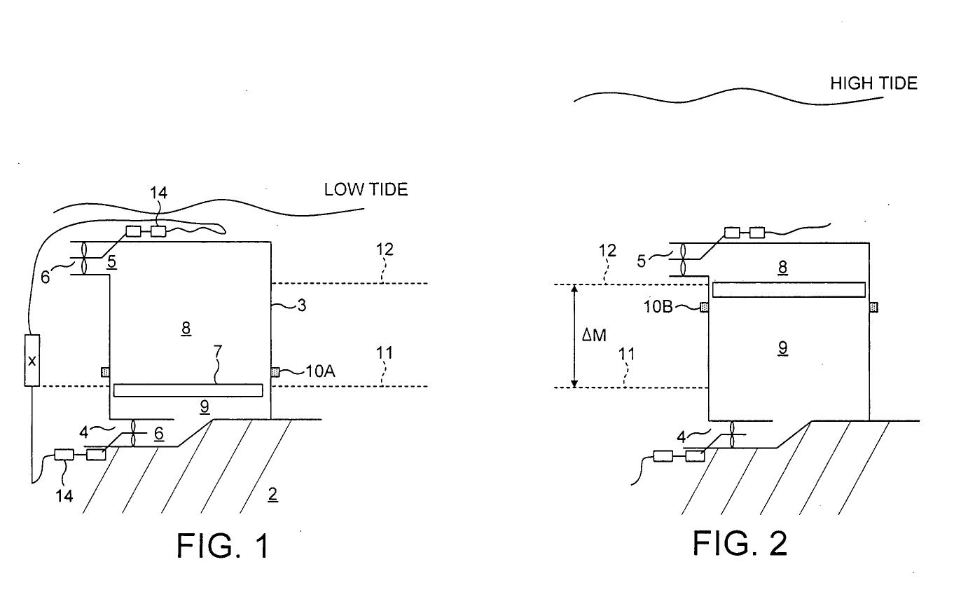

FIG. 1 shows a tidal generation unit in its low-water state;

FIG. 2 shows a tidal generation unit in its high-water state; and

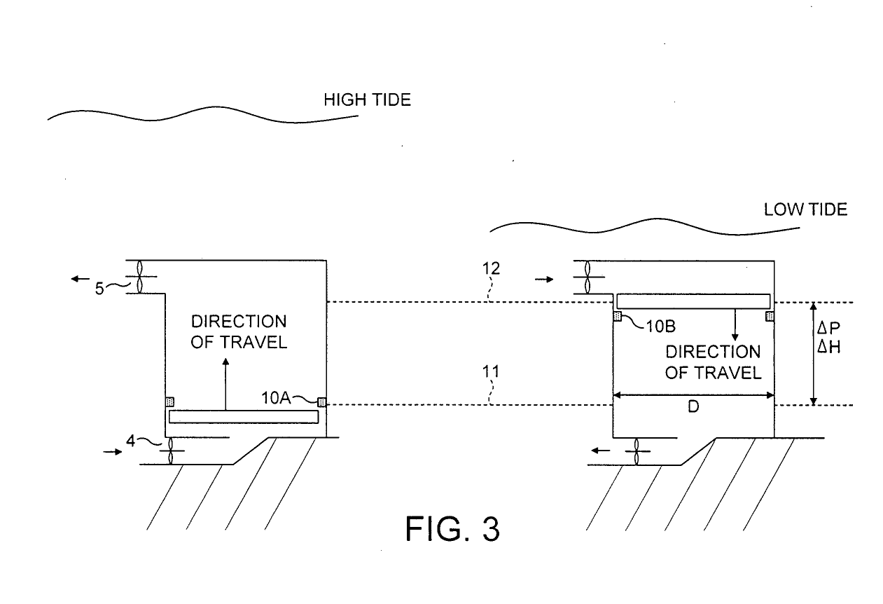

FIG. 3 shows a tidal generation unit in its storage state.

FIG. 1 shows a tidal generation unit 1 mounted on the sea bed 2. The tidal generation unit comprises a hollow cylindrical column 3 extending upwardly from the sea bed. Instead of being mounted directly on the sea bed the column could be tethered to the sea bed by one or more lines or other appropriate fixings. The column is closed at its ends except for an opening (or several) 4, 5 near each end. A turbine, or number there of, 6, or other energy transfer device e.g. pelton wheel, is fitted across one, or all, of the openings so as to be driven by fluid flowing in and/or out of the opening(s). The energy transfer device could be located at any or all of the openings. A generator, or multiples thereof, 14 is coupled to the energy transfer device for generating electricity from the rotation of the turbine, which in turn could be connected to an accumulator.

In the column is a neutrally buoyant float 7 (the float could alternatively be temporarily made positively buoyant (if restrained) which fits across the interior of the column, separating the enclosed volumes 8 and 9 above and below the float.

Restraining mean 10a, 10b are provided in the walls of the housing for restraining movement of the float along the axis of the column. In this example the restraining means are simply rods that can be slid longitudinally so as to project from the interior wall of the column (as illustrated in FIG. 1) or to be flush with the interior wall. However, other types of restraining means are possible and further examples are described below.

In the preferred mode of installation, the sea level remains above the whole unit at all levels of the tide, and the neutral buoyancy float rises and falls in response to the changes in tide above. Alternatively, in a less preferred arrangement the column could be located so that during the tidal cycle the sea level moves at least over a range at least part of the way between the opening 4 and 5. The tide could go below the lower opening, but this is not preferred.

The operation of the tidal generation unit of FIG. 1 will now be described. The interior of the cylinder 3 communicates with the sea via the energy transfer device 6. Therefore, when the pins 10a and 10b are withdrawn to be flush with the wall of the cylinder, as the tide rises and falls the float 7 is urged to rise and fall. As the float rises water flows into the column through the lower opening 4 and air (or fluid) flows out of the column through the upper opening 5. Depending on which opening the turbine is located at, (or whether located at each end) the respective fluid powers the energy transfer device, generating electricity which is conducted away by cables 13 to an accumulator if required. As the float falls fluid (or air) flows into the column through the upper opening 5 and water flows out of the column through the lower opening 4. Again, the turbine(s) is turned and electricity is generated.

The restraining means 10a, 10b can restrain the float at a location in the column against the force of the tide, and then release it when required. For example, if restraining means 10a is engaged at low tide, when the float is below restraining means 10a, the float will be prevented from rising as the water level rises. As a result there will be no flow through the respective opening 4, 5. At some later time, when sea level is above the float, the restraining means 10a can be released, allowing the float to rise in the cylinder and fluids to flow through the openings 4, 5 to generate electricity. Similarly, if the restraining means 10b is engaged at high tide, when the float is above restraining means 10b, downward movement of the float can be delayed until some desired later time. In this way electricity can be generated at a time when it is required, rather than at a time governed solely by the movement of the tide. When connected to an accumulator a constant output could be achieved by the system acting similar to that of a piston.

The neutral buoyancy float need not be spherical. It could, for example, take the form of a disc. Such a disc should be provided with means such as guides or extensions to resist it tipping in the cylinder. The float preferably seals the volumes 8, 9 on either side of it from each other, but it need not do so perfectly. It is enough that it seals sufficiently that the flow of fluid through the turbine is resisted when the float is restrained in place as the tide rises or falls. Instead of a float separating regions 8 and 9, a movable separating member that is heavier than water could be used. Such a member would be forced up and down by the water and air pressures acting at the openings 4, 5 but would not fall down the cylinder if it was configured to seal volumes 8 and 9 well from each other. It will thus be appreciated that wherever appropriate, the discussion herein of designs involving floats could be applied equally to heavier-than-water (or neutrally buoyant) separating members.

The chamber in which the float moves need not have its axis vertical, but the neutral buoyancy float should be able to move along the chamber, so that it can be forced up and down by changes in pressure and density of the fluid.

The restraining means could take any suitable form. For example, there could be chains attached to each side of the float which each run through a respective ratchet that can be engaged or disengaged on demand. Alternatively there could be one or more valves across either or both of the openings 4, 5 that can be opened or closed on demand. Electromagnetic engaging mechanisms may be used for example. Preferably the restraining means is capable of restraining the float at a multiplicity of locations in the column, so that energy can be recovered from the generation unit on demand. The restraining means is preferably controlled remotely, for example by wired or wireless connections to a control centre.

Instead of a turbine other forms of fluid-driven device could be used (e.g. a Pelton Wheel). Alternatively, energy could be recovered from the motion of the float, as fluid flows through either or both of the openings, via a direct mechanical linkage to the float itself.

Compared to conventional wave and tidal generators, It will be fairly wide to maximise surface area over distance traveled, reducing its visual impact and any impediment to shipping. No barrage is needed as for normal tidal generators. In most cases the equipment may be fully submerged causing no visual impairment. The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A device for harnessing tidal energy, comprising:
a vertically elongate chamber at either partially or fully submerged in a tidal body of liquid;
a separating member movable in the chamber and configured to seal from each other an upper interior region of the chamber above the member and a lower region of the chamber below the member,
the chamber having a first opening whereby the lower interior region may communicate with the body of liquid and a second opening whereby the upper interior region may communicate with one or more of the atmosphere, the tidal body of liquid or another body of liquid;
energy harnessing means for harnessing energy from the flow of fluid through the first or second opening; and
restraining means for releasably restraining the motion of the separating neutral buoyancy member in the chamber.

2. The device according to claim 1, wherein the chamber is fastened to the bed of the tidal body of liquid.

3. The device according to claim 1, wherein the cross-section of the chamber is circular.

4. The device according to claim 3, wherein the separating member is matched to the inner wall cross section.

5. The device according to claim 1, wherein the separating member is capable of floating on the liquid or is under neutral buoyancy submerged within the fluid.

6. The device according to claim 1, wherein the restraining means is remotely controllable to release or restrain the motion of the separating member.

7. The device according to claim 1, further comprising an electrical generator arranged so as to be driven by the flow of fluid through the first or second (or simultaneous) opening.
